(19) United States
(12) Patent Application Publication
(10) Pub. No.: US 2009/0260648 A1
(43) Pub. Date: Oct. 22, 2009

(54) Cosmetic application guide

(75) Inventor: Daniel Castelluccio, New York, NY (US)

Correspondence Address: PRYOR CASHMAN, LLP, 7 Times Square, NEW YORK, NY, 10036-6569, US

(73) Assignee: Cobalt Balloon, LLC

(21) Appl. No.: 12/148,424

(22) Filed: Apr. 18, 2008

(51) Int. Cl. A45D 44/00; G09B 19/00

(52) U.S. Cl. 132/200; 434/100

(57) ABSTRACT

A transparent sheet with a desired front face image clings by static to a mirror. The front face image is provided with cosmetic indications which, when the sheet is adhered to a mirror, allows the user to refer to the front face image to apply cosmetics to her own face.

### BACKGROUND OF THE DISCLOSURE AND DESCRIPTION OF THE INVENTION

The present invention relates to a device and method for facilitating the application of make up and cosmetics by an individual consumer in a professional manner with high-fashion looks and quality results. The present invention is also intended to enable a consumer to replicate the fashion and cosmetic suggestions of others in application of make up and cosmetics to their own face by using the suggestions, provided on a “cheat” sheet of preferably transparent material adhered to a mirror, which the user can refer to when make up is applied to her face. Various applications of make up and cosmetics to areas of one's face, for example to the eyes, nose, cheek lines, brows, lips, etc. can be easily and quickly performed by having the consumer follow the provided image of a similar or identical face, which can be that of a model, a computer-generated “perfect” face, or the person's own front facial image. The transparent sheet is initially provided with the suggested areas and colors and blends of application of the preferred make up and cosmetics applied thereto at the same areas of the person's image as the person will try to replicate onto their face. The consumer merely copies, as appropriate and as desired, the make up and cosmetics, where and how (color, intensity and blending) applied on the transparent sheet's front face image onto her actual face for enhanced and possibly seemingly professional results.

According to the invention, the model face on the transparent sheet, whether of a perfect face, a model's face or the consumer's front face image is initially printed or otherwise applied to a sheet of transparent, thin, material, a piece of acetate works well, as is available from art supply stores. Preferably the sheet is transparent plastic, a thin sheet which has a static cling characteristic enabling it to be easily removed from a paper or cardboard backer sheet and just as easily precisely placed (and held by its static cling characteristic) onto a bathroom or other mirror surface. At the time of purchase of the same, the image is provided with sample cosmetic applications onto the various locations corresponding to the user's face. Also, at the time of purchase, preferably, the user will purchase new cosmetics corresponding to the type (lip color, eye shadow, rouge, concealer, etc.) of makeup, and in color so that the user can actually apply the same to her own face. To replicate the image provided by the suggested image of the face on the transparent sheet, the user refers to the areas on the sheet's face and applies the corresponding cosmetics to the same respective areas of her own face.

As suggested above, the image on the transparent sheet will have been previously provided with the suggested cosmetics and make up, in the proper areas and in the proper colors, blending and amounts of application. So, for example, high cheek bones will have rouge, the lips provided with a specific color of lipstick, the upper forehead provided with concealer for hiding brow lines, etc. Preferably, the suggestions are provided by a professional make up artist, usually located at the site of sale and purchase of the cosmetic products. All of the cosmetics and make up applied to the front face image on the transparent sheet will hopefully also be sold and provided to the consumer (although, of course, the consumer can use pre-existing cosmetics already bought and at home) in the same colors and types as provided on the sheet. So, for example, the consumer is provided (by offering for sale and the consumer's purchase) with the same color rouge, lipstick, eye shadow, eye liner and concealer and, of course, applicators to transfer the cosmetics from their packages to the consumer's face.

In use, the consumer will, after purchase and traveling home, physically remove and transfer the transparent sheet from its storage container (an envelope) backed on a sheet of paper or cardboard, onto a mirror. The user does this by simply peeling off the acetate from the paper or cardboard backer. Then, facing a mirror, the user will locate (at her approximate height) the front face image of the transparent sheet to the mirror. Preferably the mirror is a large, vertically hung mirror in a bathroom, where the user generally applies her make up or cosmetics. The static dinginess and characteristic of the transparent acetate sheet will allow it to easily, yet temporarily, “adhere” to the mirror since the plastic sheet will tend to hold onto clean and smooth glass or mirror by static electricity. The transparent sheet can either be slidingly moved on the mirror into position adjacent the viewed image of the consumer's actual face or placed directly at the location where the consumer would see her own face image in the mirror. The front image of the face provided by the transparent sheet is either, adjacent the user's actual image in the mirror or superimposed over her actual image, as reflected by the mirror-surface. The front face image provided by the transparent sheet (now adhered to the mirror) is, preferably, a high fashion model face or the actual user's face, which has been previously provided with the desired make up elements or “look” desired by the consumer.

The front face image on the transparent sheet is preferably provided in black and permanent ink or marker so that the cosmetics, so that it is permanently printed onto the transparent sheet for reuse. However, if desired, the cosmetics applied can be erased, amended or modified over time as styles and fashion changes. As desired, the consumer will use her applicators and cosmetics/make up and by viewing the made up image on the transparent sheet, adhered to a mirror surface, bearing the face of the model or herself, to try to replicate as close as desired, the location, color, blending, etc. of the make up and cosmetics onto her own face. The rouge, lipstick, eye shadow, liner, and concealer, etc., for example, from the front face image of the transparent sheet will, one at a time, be applied to the consumer's actual face, while she looks into the mirror for facilitating application onto her face and while also using the transparent sheet and its image (next to or over her own image) as a reference. The two images will, if desired, become strikingly similar if not exact to one another. Each cosmetics is applied to the user's face after consulting with the adjacent image on the transparent sheet. Each cosmetic is applied in the color, location and blending suggested by the transparent sheet. Each cosmetic is taken from its carrying case or compact and transferred by suitable cosmetics applicators to the user's actual face.

Then, after application is complete, the transparent sheet can be easily stripped off or removed from the mirror, placed onto its backing sheet (for potential reuse) and stored for another use or thrown out.

A single consumer can be provided with a set of transparent sheets, each with the model's face or her own, each with a different style or look of cosmetic application to enable her to apply make up and cosmetics in different circumstances. So, for example, different times of day require different looks, different events also dictate different look, etc. So, for example, a business day look can be provided which may be toned down from the look intended for an evening formal function, like a friend's wedding. A funky cosmetic look or style can be provided for “clubbing” while a different cosmetic look or style can be provided for going to the beach. Different lighting, incandescent, candle, or fluorescent can also dictate different cosmetic looks and styles, all to maximize the attractiveness of the individual.

Also, the make up or cosmetics applied to the front face of the model (or individual) on the transparent sheet of plastic can be permanently printed thereon and can be made to resemble or look like an animal face, for example, a tiger, a cat, a rabbit, etc. for masquerade purposes; a team mascot, for use at attending sporting events; or another interesting effect, for example, a look of a snake, a flower, etc. Thus, the present invention can be used to enable a consumer to replicate a design onto his or her face for use in attending a masquerade party, a tail gate party, a Super Bowl party, a game, or even everyday wear, where the user wants his or her face to look like something other than an un-made up face.

### DESCRIPTION OF THE PRIOR ART

U.S. Pat. No. 6,598,608 to Downey, issued 2003, for a cosmetics sampling method and cosmetics sampler film. Here, however, the transparent film, bearing for example, different colors of lips and the name or number of the shade, is intended to be superimposed directly over the user's actual body part, e.g., over their lips, then looking into a mirror to note the reflected image and name/number for help in purchasing the cosmetic depicted. The present invention, on the other hand, contemplates using static cling transparent film with pre-applied cosmetics and adhering it to the mirror to help the person apply make up so as to replicate the colors and blends from that seen on the mirror to one's face.

U.S. Pat. No. 7,1655,59 to Goodman relates to a cosmetic kit with a backing portion housing receptacles for containing cosmetics. The kit is provided with an image of a face and for each location of a face to be applied with make-up has the cosmetic container secured and located behind that area of the image so as to allow a user to obtain that cosmetic from the front of the kit at that area of the kit and apply it to the user's face. One can easily appreciate that invention by looking at the drawing showing the kit. The receptacles are in shapes which represent the portion of the face on which each type of cosmetic is to be used.

U.S. Pat. No. 5,971,763 to Yau shows a make-up mannequin kit having a soft skin make-up mannequin head having an oval face and a set of flexible masks which mount upon the head. Each flexible mask corresponds to a different skin tone of the skin tone and color of different ethnic groups. This allows an in-training cosmetologist to learn the colors and blending of cosmetics on different ethnic colors and skin tones.

U.S. Pat. No. 4,886,079 is a cosmetic template for use with applying cosmetics. A thin yet formable (likely transparent) sheet of plastic is pressed, when warm, over the wearer's face to cause it to mold, upon cooling, into the wearer's face shape. Small round openings are first market and then cut through the mask where various facial contours of the wearer are visible. The sheet, like a mask, is provided with an elastic band to facilitate remounting to the wearer, when desired. A pencil is then poked through the openings of the mask, where the lines of contour are located, to mark the wearer's face at the locations of the contour lines. Then the template is removed and cosmetics applied within the pencil lines marked on the face.

U.S. Pat. No. 4,957,124 is another patent to Mooney (as is the '079 Patent, just above) and is a template for marking a person's face made again from a formable sheet of plastic placed on hot or warm and forced to mold the face's shape. Again, small circles are marked on to the formed sheet to define the facial contours. Openings are then drilled or punched through the holes along the contour lines. Then, when desirably used, the mask is placed on the head (held with elastic in the back) and a marker pokes through the holes to provide the contour lines. Then the user removes the mask and places appropriate concealing cosmetics on the contour lines.

U.S. Pat. No. 5,178,169 to Lamle is a flexible strip of plastic material divided into a series of zones for allowing a different color, shade or tone to be placed in adjacent areas for visual comparison purposes. Each area is marked with the mirror image of the number or name of the corresponding color, shade or tone so that you can view the same in the mirror and easily determine the shade, color or tone the user likes most on their skin. The strip can be flexed over the skin to allow for bringing it close for comparison purposes to facilitate selection before purchasing.

### BRIEF DESCRIPTION OF THE DRAWINGS

FIG. 1 shows a sheet of transparent plastic (held onto a white backer of paper or cardboard) which has a permanently printed upon outline of the front face or visage, head on, of a high fashion model which has then been provided with applied cosmetics to areas demarked with various cosmetic types, colors and strengths to provide a first intended look to be copied by the consumer. At the bottom of the Figure is a representative cosmetic compact, with three sections, corresponding for the example, to the blush and concealer colors intended to be placed onto the user's face, where the same color of the cosmetic appears on the model's face.

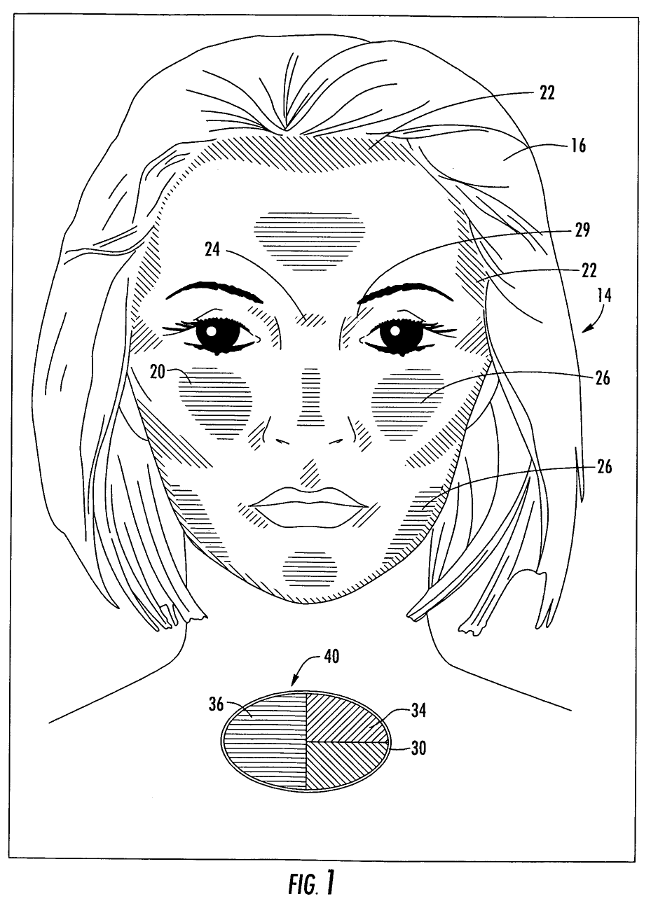

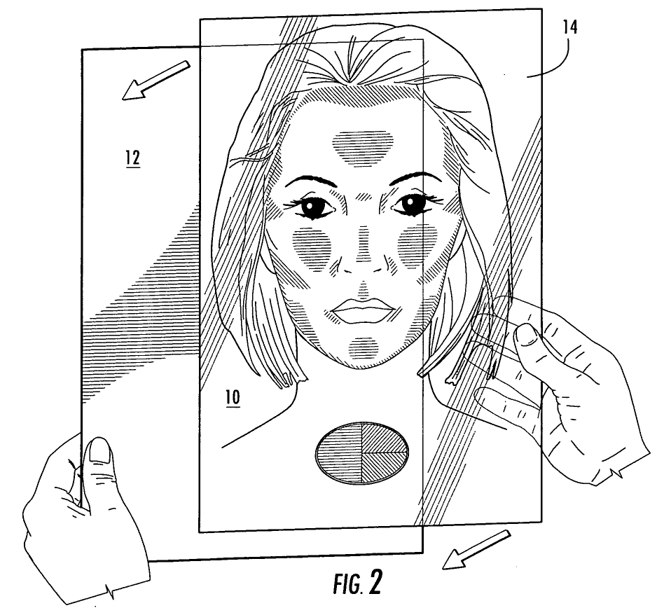

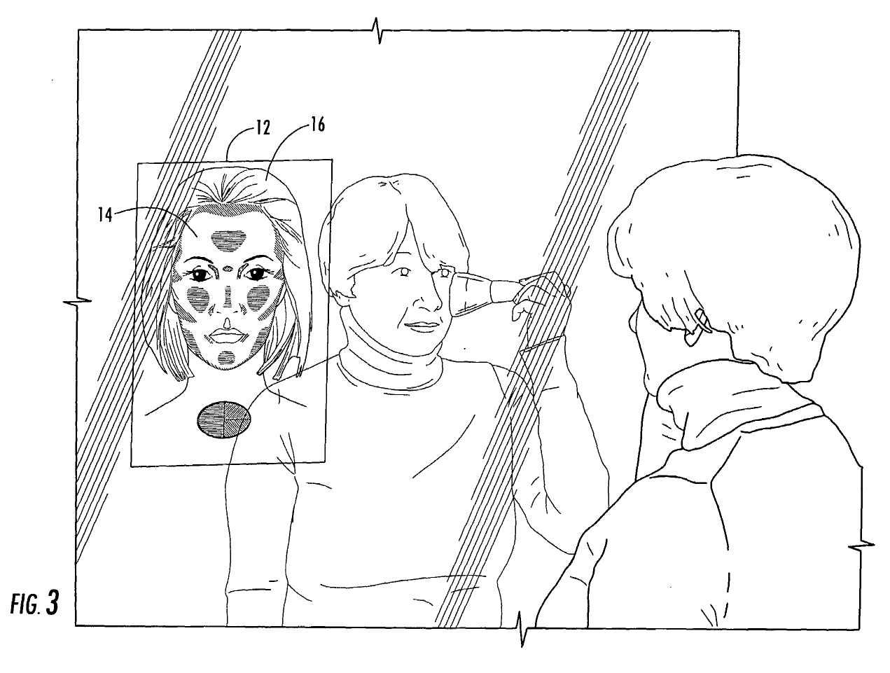

The transparent sheet of FIG. 1 is shown as it is purchased by a consumer from a cosmetic selling store, alternatively possibly bought through the Internet or through a television sales organization, like QVC or Home Shopping Club. It carries both the preferably permanently printed front face image of a model (or alternatively a rendering of the user's front face) and is then applied with markings or actual cosmetics corresponding to the cosmetics intended to be applied to the user's face. Prior to taking the transparent sheet shown in FIG. 1 to their home environment for application of cosmetics onto their face, a professional or other knowledgeable cosmetic application individual will have either spent time with the consumer (to analyze her face and contours, preferences for color, etc.) or the seller can merely provide one or more of the sheets with stylistically preferred more generic looks/styles for the mass consumer market. In any event, each sheet is provided with an outline of a face and the preferred location, type, blending, etc. of the make-up and cosmetics to be applied for the “look” or style desired by the consumer. The cosmetics are either applied to the sheet or printing onto the sheet provides the user with a visual set of clues as to the proper amounts and colors, at the precise locations on a face for a particular pleasing look and visual effect. The consumer is intended to try to replicate, as and to the extent desired, the style and look provided by the transparent sheet on the model's face from the sheet to her own face. This is accomplished by locating the transparent sheet on a mirror and the user viewing the model's face and using it as a guide for the application of cosmetics onto her own face. To accomplish this, the user will use of the same or similar cosmetics being applied in the same amounts, colors and at the indicated locations. This is intended to be made far easier than “cheat sheets” of the past by the use of t he transparent sheet, temporarily adhered or held on a mirror surface adjacent to or overlying the image of the face of the consumer as seen by the consumer in the mirror.

FIG. 2 shows the hands of a consumer removing the transparent sheet from the backing sheet, the first step in the actual use of the invention by the consumer in her bathroom or at a location where there is a mirrored surface.

FIG. 3 shows the consumer looking into the mirror and seeing her face (here, adjacent to the face of that provided by the transparent sheet) with the consumer using a cosmetic applicator to apply the purchased cosmetics onto her face at the locations, using the right colors, and blending, all as provided by the transparent sheet and the model, with cosmetics applied. The consumer is attempting to replicate, as desired, the various cosmetics from the locations, strengths and colors of the model face of the transparent sheet onto her actual face in the same relative strengths, colors and locations by looking at the model's face and then the image of her face adjacent thereto, while applying make up to her face.

It should be appreciated that the consumer can follow the directions (areas of the model's face and the cosmetics in the compact) could be sequentially numbered to further help the consumer transfer the right cosmetics from compact to face based on the numbering provided by the transparent image areas and/or those of the compact. The consumer will follow, cosmetic by cosmetic, area by area, color by color, to achieve the now made up face of the consumer, so that it substantially is identical to that of the front face image provided on the transparent sheet.

After application of the cosmetics, the user can remove the transparent sheet from the mirror (simply peeling it off and overcoming the static cling force or removing the adhesive materials) for placement back onto the backer sheet and then into an envelope for another use at another time or for disposal.

### FURTHER DESCRIPTION OF THE INVENTION AND OF THE DRAWINGS

The transparent sheet 10 is supported on a simple paper or cardboard backer, a planar element 12. The two are separated when the sheet 10 is intended to be used by adhering (by static cling or adhesive in the corners or along the edge) the sheet to a mirrored surface. The sheet 10 has a woman's front face image 14 preferably permanently printed thereon. Preferably, the user's hair style 16 is provided or, alternatively, the model is provided with a generic hair style.

The front face image 14 is then provided with various areas 20, 22, 24, 26, etc. to which cosmetics are preferably applied to provide the look or style of the model's image to the user/consumer. Here, for illustrative purposes and for simplicity of appreciating the invention, the lips and eyes have been ignored and the make up substantially only corresponds to the preferred application of rouge and concealer. Schematically shown in FIG. 1 is a cosmetic package or compact for cosmetics. In this example, three different types or colors of rouge and concealer are intended to be provided which will be applied to the user's face. Each of the cosmetics are numbered, colored or otherwise associated visually with the areas of the face of the model on the transparent sheet, to facilitate the intended replication of the model's look to the user's face. So, for example, the darkest areas of the face of the user will be replicated to those of the model, areas 20, and thus provided with the darkest cosmetic provided by the cosmetic package, from location 30 of the cosmetic device 40. The middle color 36 of the cosmetic package 40 will be applied to the user's face areas corresponding to the face areas 26 of the model's face of the transparent sheet. Then, for this purpose, the very light areas 24 of the model's face will serve as the reference point for corresponding areas of the user's face and the user will apply the lightest color 34 of the compact 40 thereto. After the rouge and concealer is applied, step by step, area by area, the user can continue to apply eye make and lip make up, too. This c an be provided on the same transparent sheet or can be provided by separate sheets. The consumer can mix and match the lips, eyes, rest of the face, as desired and the overall look or style can be seen since each model face is on a transparent sheet and the looks of each sheet will be visible through the other sheets. Since the sheets are static clinging (or adhesive is used) they can be used one atop the other and they will all hold to the mirror or to one another. The outside lines of the front face image will line up and be superimposed over one another and the overall look of the made up model will be fully visible i.e., with eyes, lips and overall face being shown for replication.

The transparent sheet can be reused by merely re-adhering it by static cling to a mirror or adhesively adhered to a mirrored or glass-like surface. The cosmetics can actually be brushed onto the transparent sheet or printed or marked by color or other coordinated markings between cosmetics and areas of the model's face. When one style is finished, the cosmetics, if applied by grease pencil or by use of actual cosmetics applied thereto, can be easily removed from the transparent sheet by a tissue or other cosmetic's remover and another style or “look” then applied or provided. However, according to the preferred form of the invention, the front face image of the face on the transparent sheet (whether the actual shape and look of the consumer or a model's desired face) is permanently printed thereon.

The application of cosmetics to the transparent sheet can be provided with a grease pencil or pencils, by use of cosmetics directly applied to the acetate sheet, by use of simple colors in areas, numbers or other visual indications (patterns of cross hatching, for example) which correspond to the colors, numbers or other indications (cross hatching) in one or more cosmetics cases carrying the make up and cosmetics to facilitate the transfer of the cosmetics, held in the cases or compacts, onto the consumer's face at the locations, in the colors and strengths/blends indicated on the model's face to the user.

The transparent sheet is preferably thin plastic and available at many art supply stores in various thicknesses. It has a static cling characteristic such that it will hold onto, without the use of adhesives, a flat piece of glass or mirror. Of course, the present invention can be formed from other materials and may, for various reasons, need the use of adhesive or supplemental affixing elements, e.g., pieces of tape at the corners, glue dots, edges of semi-permanent adhesive as used in Post-It Notes made by the 3M Corporation, etc. The sheet can be pre-printed, permanently or not, with the front face image of a model's face with hair or not or with the visage of the consumer's face. Alternatively, the sheets can be sold in a variety of somewhat conventional or more generic face shapes, e.g., round, long, thin, fat, Caucasian, African, Asian face colors, etc. and then the professional can apply the desired cosmetics or cosmetic indicators to the transparent sheet. In an alternative embodiment of the invention, the sheet need not be even transparent but, rather, all that would be required is for the sheet to be static clingable to the mirror with the desired face, with cosmetics, shown thereon so that the consumer can refer to the same for use in making up her own face.

The face of the sheet can be either sold with different styles or looks already applied to the face or the salesperson at the location of the cosmetic buying decision, usually at the floor of a high end department store, for example, where cosmetics are hawked and sold, can do the application of desired products and looks to the face on the transparent sheet. The consumer, physically buying the actual cosmetics applied to the transparent sheet and armed with the transparent sheet as reference material, then returns home for use of the sheet and the cosmetics, in the manner described above.

When it is desired to have the consumer's face made up to resemble the face of the transparent sheet, using the cosmetics either on hand or purchased for this purpose, the consumer will remove the transparent sheet from its cardboard backer and package. She will then apply the sheet to a piece of glass, preferably her bathroom mirror at or about the same height as her face would appear when she applies make up. The consumer can either apply the sheet in the center of the mirror so that her viewed image is superimposed over the image of the transparent sheet or adjacent to her viewed image of her own face. In any event, the consumer will then use the applicators and make up on hand and, step by step, area by area, cosmetic by cosmetic, will track the model face of the transparent sheet and replicate the same by applying cosmetics to her own face. As mentioned, the entire process can be simplified if the cosmetics or more accurately stated the compartments or containers for the cosmetics are number, lettered, or otherwise identified and coordinated to the areas, cosmetics, in color, intensity, and shape as depicted on the front face image of the transparent sheet. This will make the process that much easier for the consumer. In this manner, the consumer will hopefully be led, step by step, area by area, cosmetic by cosmetic, to replicate the cosmetic image of the face of the model (or the consumer's own face or face type) as shown on the transparent sheet onto her own face. A hoped-for beautiful replication is intended and expected, facilitated by the present invention.

Upon completion, the transparent sheet can be discarded or removed and stored for another use.

Another embodiment of the invention relates to the use of one or more transparent sheets, as described above, which are provided with integrated circuitry attached thereto or otherwise associated therewith, with the sheets and circuitry being connected to a visual or audible set of one or more instructions to guide/aid the consumer in the application of the make-up shown on that sheet. The instruction set directs the consumer how and where, audibly or visually, to apply the cosmetics to the face. Then, when that set of instructions is completed, the integrated circuit is prompted (or otherwise times out) and the next set of instructions then presented to the consumer. Here, too, as previously described, the individual sheets can be overlaid, one upon another, so that as the instructions are carried heard or seen, one after another, the image seen on the transparent sheet and/or the mirror will reflect that taught by the integrated circuit. All the while, during the presentation of the set of instruction sets, the consumer is applying the make-up to her own face according to the instructions, so that, at the end, her face tends to look similar to that of the face shown on the transparent sheet or set of sheets. The integrated circuitry, battery, and speaker, can be connected to the transparent sheets via integrated wiring in the sheets, or electrically connected pathways and the set of instructions can require the user/consumer to prompt or push a button(s) to indicate that the user is ready for the next set of instructions. The battery power, the speaker, the pathways within the transparent sheet can be housed within a small vertical strip which is adapted to either sit on a countertop or can even be adhered, temporarily, to the mirror surface.

I claim:

1. A method of applying cosmetics to a face comprising the steps of:
providing a transparent sheet with at least a section of the front face image of a desired cosmetically-applied face thereon;
affixing said sheet to a flat glass like or mirror surface; and
using said image of the of said transparent sheet as a reference for application of cosmetics to the face of the user as seen in the mirror.

2. A method as claimed in claim 1 wherein said affixing is accomplished by static cling.

3. A method as claimed in claim 1 wherein the method further comprises providing cosmetics which are coordinated to the cosmetically applied face of said transparent sheet.

4. A facial cosmetic-replicating sheet comprising a transparent sheet of static-cling material having an image of a made up face thereon with cosmetic indicators located at various areas in various colors showing a desired image of the made up face to be replicated by a consumer.

5. A facial cosmetic replicating sheet as claimed in claim 4 and further comprising cosmetics which correspond to said cosmetic indicators.
